(19) United States
(12) Patent Application Publication
(10) Pub. No.: US 2015/0328992 A1
(43) Pub. Date: Nov. 19, 2015

(54) SYSTEM AND METHOD FOR BRAKING OF MACHINE

(71) Applicant: Caterpillar Inc., Peoria, IL (US)

(72) Inventors: Deepak R. Amaravadi, Forsyth, IL (US); Karl Schneider, Decatur, IL (US)

(73) Assignee: Caterpillar Inc., Peoria, IL (US)

(21) Appl. No.: 14/279,368

(22) Filed: May 16, 2014

(51) Int. Cl. B60L 7/18; B60T 8/172

(52) U.S. Cl. CPC B60L 7/18; B60T 8/172

(57) ABSTRACT

A method of braking a machine having an electric retarding system and a friction brake system is disclosed. The method includes determining a desired retarding torque based at least in part on an operator input. The method further includes determining a maximum retarding torque of the electric retarding system based at least in part on a maximum grid fan speed. The maximum grid fan speed is predetermined according to a noise requirement of the machine. The method also includes actuating the electric retarding system to supply an output torque based on the desired retarding torque and the maximum retarding torque. The method includes actuating the friction brake system to supply a friction braking torque if the output torque is lesser than the desired retarding torque.

### TECHNICAL FIELD

The present disclosure relates to a braking system for a machine, and more particularly to a braking system and a method combining electric retarding and friction braking in a machine. The present disclosure is also related to a braking system and method for reducing noise in a machine.

### BACKGROUND

A typical machine has a braking system to control, decelerate and/or stop the machine. Exemplary machines include passenger vehicles, dump trucks, mining vehicles, agricultural vehicles etc. Machines having an electric drive system to provide propulsion are also well known in the art. The electric drive system typically includes motors which provide propulsion. An engine may be used to power the electric drive system.

The braking system may utilize various components of the electric drive system to provide braking for the machine. For example, the motors may be used to provide a braking torque. The braking torque generated by the motors may be dissipated in the form of heat in a resistor grid. One or more fans may be provided to blow air over the resistor grid in order to enhance heat dissipation. However, the fans tend to generate noise at high speeds thereof which may also occur under normal operating conditions. Such noise may be undesirable.

The braking system may also include a friction braking system associated with one or more wheels of the machine. The friction braking system may supplement electric braking system during certain conditions, such as unfavorable terrain, heavy loading, unfavorable underfoot conditions etc. However, in certain cases, combining electric braking and friction braking may give rise to instability, such as locking of the wheels.

US Patent Application 20100025167 discloses a method of braking a machine having an electric drive configuration. The electric drive configuration includes at least one electric retarding system connected to a first set of wheels. Additionally, a front brake module system connects to the first set of wheels to provide a braking output torque. A second friction brake system connects to a second set of wheels and provides a second braking output torque. The system calculates and applies a braking ratio between the electric and friction braking systems based upon both user controls and conditions encountered.

The present disclosure is directed to mitigating or eliminating one or more of the drawbacks discussed above.

### SUMMARY OF THE DISCLOSURE

In one aspect of the present disclosure, a method of braking a machine having an electric retarding system and a friction brake system is disclosed. The method includes determining a desired retarding torque based at least in part on an operator input. The method further includes determining a maximum retarding torque of the electric retarding system based at least in part on a maximum grid fan speed. The maximum grid fan speed is predetermined according to a noise requirement of the machine. The method also includes actuating the electric retarding system to supply an output torque based on the desired retarding torque and the maximum retarding torque. The method includes actuating the friction brake system to supply a friction braking torque if the output torque is lesser than the desired retarding torque.

In another aspect, a method of braking a machine having an electric retarding system and a friction brake system is disclosed. The method includes determining a desired retarding torque based at least in part on an operator input. The method further includes determining a maximum retarding torque of the electric retarding system based on at least a maximum grid fan speed. The maximum grid fan speed is predetermined according to a noise requirement of the machine. The method also includes actuating the electric retarding system to supply an output torque based on the desired retarding torque and the maximum retarding torque. The method further includes actuating the friction brake system to supply a friction braking torque if the output torque is lesser than the desired retarding torque. The friction braking torque is selectively split between a front brake system associated with a front set of wheels and a rear brake system associated with a rear set of wheels based at least in part on a ratio between the friction braking torque and the desired retarding torque.

In yet another aspect, a machine is disclosed. The machine includes a front set of wheels and a rear set of wheels. An electric retarding system is associated with the rear set of wheels. The machine further includes a friction brake system. The friction brake system includes a front brake system associated with the front set of wheels and a rear brake system associated with the rear set of wheels. A control module is coupled to the electric retarding system and the friction brake system. The control module is configured to determine a desired retarding torque based at least in part on an operator input and determine a maximum retarding torque of the electric retarding system based on at least a maximum grid fan speed. The maximum grid fan speed is predetermined according to a noise requirement of the machine. The control module is further configured to actuate the electric retarding system to supply an output torque based on the desired retarding torque and the maximum retarding torque. The control module actuates the friction brake system to supply friction braking torque if the output torque is lesser than the desired retarding torque. The friction braking torque is selectively split between the front brake system and the rear brake system based on a ratio between the friction braking torque and the desired retarding torque.

### BRIEF DESCRIPTION OF THE DRAWINGS

FIG. 1 is a side view of an exemplary machine, according to an embodiment of the present disclosure;

FIG. 2 is a block diagram illustrating an electric drive system of the machine, according to an embodiment of the present disclosure;

FIG. 3 is a block diagram illustrating a braking system of the machine, according to an embodiment of the present disclosure;

FIG. 4 is a logical block diagram illustrating determination of a desired retarding torque, according to an embodiment of the present disclosure;

FIG. 5 is a logical block diagram illustrating determination of a retarding torque ratio, according to an embodiment of the present disclosure;

FIG. 6 is a logical block diagram illustrating actuation of a friction braking system, according to an embodiment of the present disclosure; and

FIG. 7 is a flow chart illustrating a method of braking the machine, according to an embodiment of the present disclosure.

### DETAILED DESCRIPTION

The present disclosure relates to a braking system and method for a machine. The braking system includes an electric retarding system and a friction brake system.

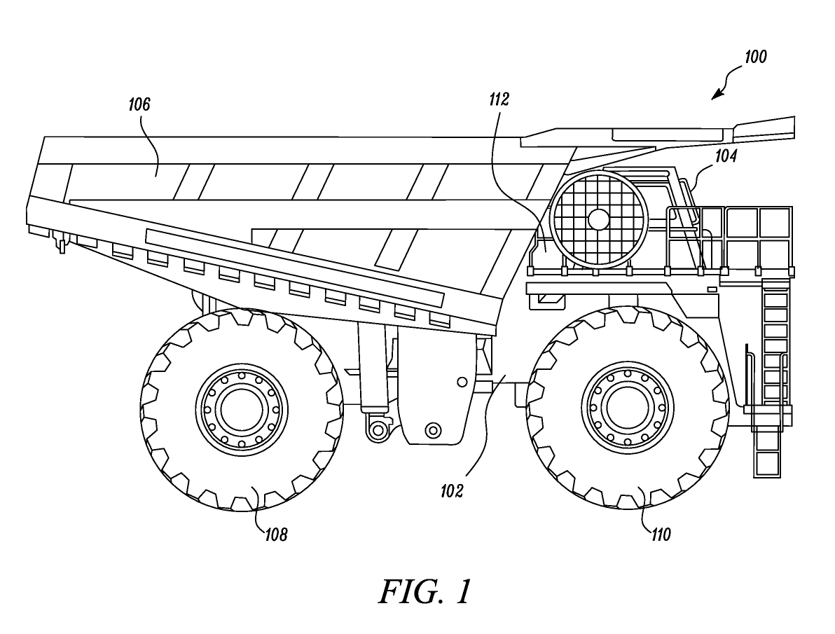

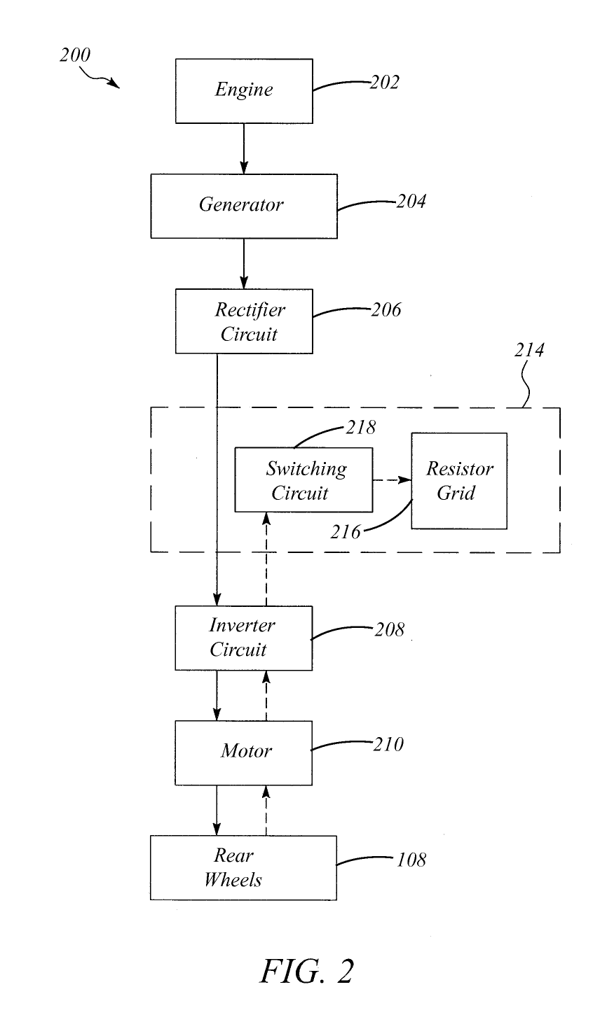

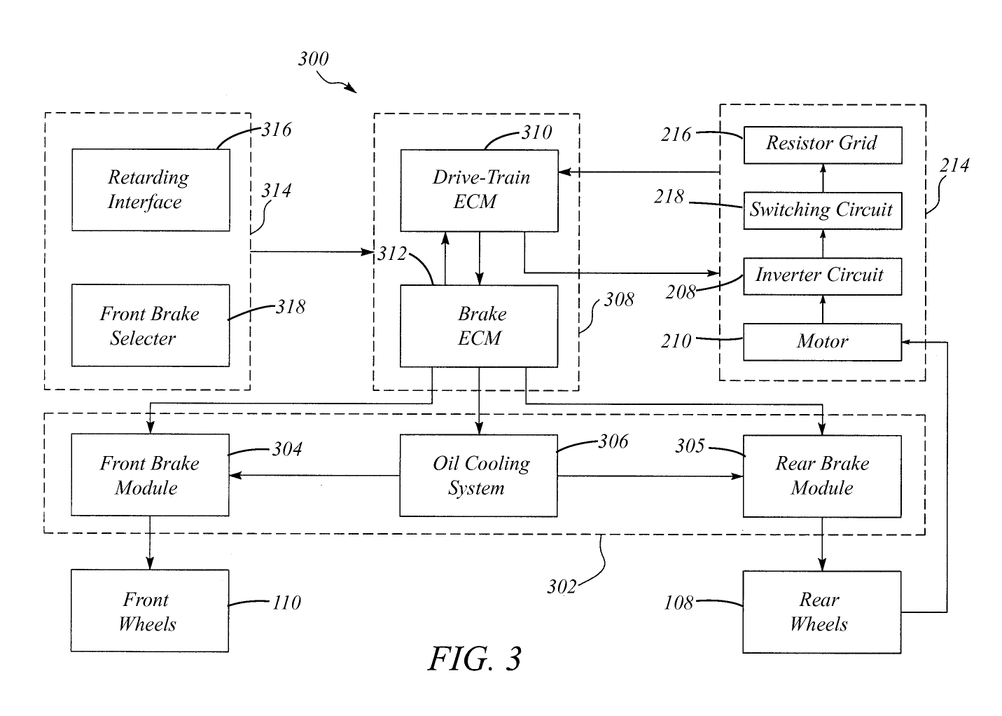

FIG. 1 illustrates a side view of an exemplary machine 100, according to an embodiment of the present disclosure. The machine 100 may include any machine that may be used for the purpose of construction, mining, quarrying, and so on. The machine 100 may also include passenger vehicles, earthmoving machines, or off-highway vehicles. In the embodiment of FIG. 1, the machine 100 is an off-highway truck that includes an electric drive system 200 (shown in FIG. 2). The electric drive system 200 includes the electric retarding system 214 for controlling, decelerating and/or stopping the machine 100. The machine 100 includes the friction brake system 302 (shown in FIG. 3) for supplementing the electric retarding system 214 during braking of the machine 100.

The machine 100 includes a chassis 102 that supports an operator cab 104 and a bucket 106. The bucket 106 is pivotally coupled with the chassis 102 and is adapted to carry a load. The operator cab 104 may include one or more buttons, a display, pedals and/or levers to control and monitor various parameters of the machine 100. Further, a rear set of wheels 108 is disposed at a rear of the machine 100 and a front set of wheels 110 is disposed at a front of the machine 100. The electric drive system 200 of the machine 100 is drivably coupled with the rear set of wheels 108 for transmitting motive power from a power source. The power source is embodied as an engine 202 (shown in FIG. 2). The front set of wheels 110 may be coupled with a steering system (not shown) to steer the machine 100 as desired by an operator. However, in an alternative embodiment, the front set of wheels 110 may be drivably coupled with the electric drive system 200 to propel the machine 100, while the rear set of wheels 108 may be steered. In yet another embodiment, both the front set of wheels 110 and the rear set of wheels 108 may be drivably coupled with the electric drive system 200, and one of the front set of wheels 110 and the rear set of wheels 108 may be steerable. Moreover, one or more additional sets of driven or non-driven wheels (not shown) may be provided. In FIG. 1, the chassis 102 may be embodied as a rigid chassis. However, other machine configurations, for example, an articulated chassis with one or more driven set of wheels, may be contemplated within the scope of the present disclosure.

FIG. 2 shows a block diagram illustrating the electric drive system 200 of the machine 100, according to an embodiment of the present disclosure. In the block diagram, a flow of driving power during the propulsion of the machine 100 is represented by solid lines and a flow of power during retarding of the machine 100, hereinafter referred as ‘retarding power’, is represented by dashed lines. The electric drive system 200 includes the engine 202. The engine 202, in an embodiment, is an internal combustion engine run by gasoline, diesel, biogas, natural gas, or a combination thereof. The engine 202 may have one or more cylinders (not shown). Further, the engine 202 may be selected from various configurations, such as inline, rotary, V-type engines etc. The engine 202 generates a power at an output shaft (not shown). The output shaft of the engine 202 is drivably coupled with a rotor of a generator 204. In an embodiment, the generator 204 may be an alternator or any other electric power generating device. The generator 204 may produce electric power in the form of alternating current (AC) power. The AC power is supplied to a rectifier circuit 206 that coverts the AC power into direct current (DC) power.

The electric drive system 200 further includes an inverter circuit 208 to receive the DC power from the rectifier circuit 206 and convert the DC power into AC power. The inverter circuit 208 may also be configured to selectively adjust frequency and/or pulse width of an output thereof. The output from the inverter circuit 208 is fed to motors 210. The motors 210 are drivably coupled with the rear set of wheels 108. The motors 210, for example, may include synchronous motors, induction motors, asynchorous motors, and so on. Each of the motors 210 may be coupled one of the rear set of wheels 108. In an alternative embodiment, a single motor may be drivably coupled with the rear set of wheels 108. The motors 210 may be operated at variable speeds and/or torque by adjusting frequency and/or pulse width of the output of the inverter circuit 208.

As shown in FIG. 2, the electric drive system 200 includes the electric retarding system 214. The electric retarding system 214 includes a resistor grid 216 that is configured to receive an electric power from the inverter circuit 208 via a switching circuit 218. The electric power from the inverter circuit 208 passes through the resistor grid 216 when the switching circuit 218 is closed. The switching circuit 218 is closed during electric retarding of the machine 100. During electric retarding, the rear set of wheels 108 rotate the respective motors 210, which then act as electric generators. The electric power generated by the motors 210 is in the form of AC power. The inverter circuit 208 receives the AC power and convert the AC power to DC power. This DC power is allowed to pass through the resistor grid 216 via the switching circuit 218 and dissipated as heat. Thus, the electric retarding system 214 may provide braking for the machine 100 by dissipation of the DC power from the inverter circuit 208 as heat in the resistor grid 216. The braking system, as described above, is exemplary in nature, and alternative configurations and/or additional components may be present without deviating from the scope of the present disclosure. For example, a portion of the DC power from the inverter circuit 208, during electric retarding, may be diverted to other electrical components of the machine 100 and/or stored in an energy storage device (For example, one or more batteries).

FIG. 3 shows a block diagram illustrating a braking system 300 of the machine 100, according to an embodiment of the present disclosure. The braking system 300 includes the electric retarding system 214 and the friction brake system 302. In an embodiment, the friction brake system 302 includes a front brake module 304 associated with the front set of wheels 110 and a rear brake module 305 associated with the rear set of wheels 108. The front brake module 304 coupled with the front set of wheels 110 selectively develops front retarding torque and the rear brake module 305 coupled with the rear set of wheels 108 selectively develops a rear retarding torque during braking of the machine 100. In an embodiment, a hydraulic system (not shown) may operate the front and the rear brake modules 304, 305. The hydraulic system may be actuated by operating a lever or a pedal disposed in the operator cab 104. The front and rear brake modules 304, 305 may be hydraulically actuated by a piston-cylinder arrangement. The front and the rear brakes modules 304, 305 may include a brake disc (not shown) and a friction pad (not shown). The brake disc and the friction pad may be coupled to the front and the rear set of wheels 110, 108. The friction pad may be selectively actuated by the piston-cylinder arrangement to contact the brake disc and generate a friction braking torque. Further, the friction brake system 302 includes an oil cooling system 306 that is fluidly communicated with the front and the rear brake modules 304, 305 for absorbing heat that is generated during braking of the machine 100.

In the embodiment of FIG. 3, the braking system 300 includes a control module 308. The control module 308 is communicably configured with the electric retarding system 214 and the friction brake system 302. The control module 308 includes a drive-train electronic control module (ECM) 310 and a brake electronic control module (ECM) 312. In an example, the drive-train ECM 310 and/or the brake ECM 312 may be part of a single controller. The single controller may be a microprocessor unit adapted to control the braking system 300, as will be explained hereinafter.

The braking system 300 includes a user interface 314 which acts as a link between the braking system 300 and the operator. The user interface 314 includes a retarding interface 316 for the operator to set a desired speed of the machine 100. In an embodiment, the retarding interface 316 may include a retarder lever (not shown) disposed in the operator cab 104. The retarder lever may enable the operator for selecting a desired speed for the machine 100.

The retarding interface 316 may further include a machine speed limit 412. For example, the operator may establish the machine speed limit 412 before starting the machine 100. The machine speed limit 412 may be a maximum safe value of the speed of the machine 100. The desired speed set by the retarder lever and the machine speed limit 412 are communicated to the drive-train ECM 310. However, in an alternative embodiment, the machine speed limit 412 may be predefined in the drive-train ECM 310.

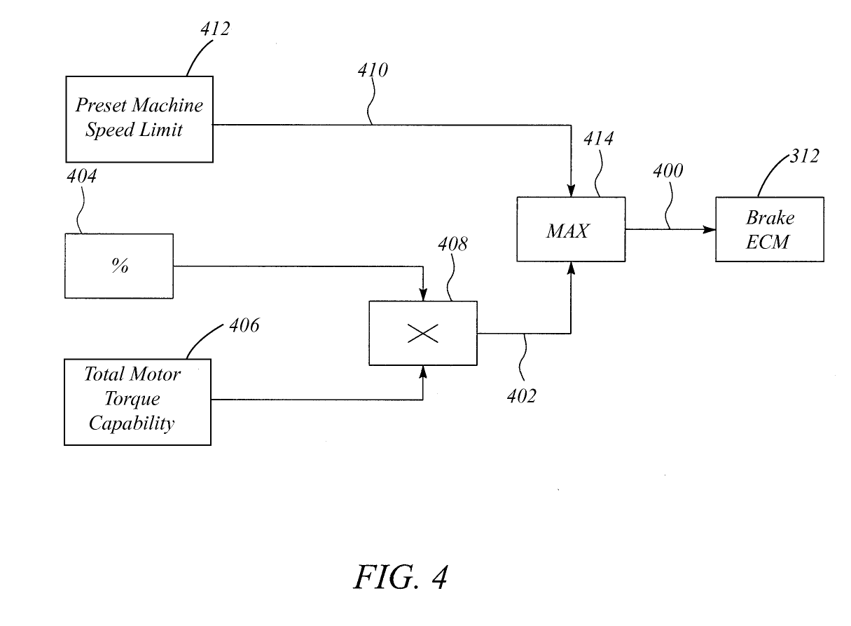

The user interface 314 further includes a front brake selector 318. The front brake selector 318 may be a lever or a button disposed in the operator cab 104. The operator actuates the front brake selector 318 based on various factors during moving of the machine 100. Such factors include terrain conditions, loading of the machine 100, and so on. The front brake selector 318 is communicably coupled to the drive-train ECM 310 and the brake ECM 312, and provides a status of the front brake selector 318. The status of the front brake selector 318 includes an engaged position and a disengaged position thereof. The front brake selector 318 is used to determine whether a fraction of the desired retarding torque 400 (shown in FIG. 4) is provided by the front brake module 304.

FIG. 4 shows a logical block diagram for determining the desired retarding torque 400, according to an embodiment of the present disclosure. The drive-train ECM 310 may execute various steps described with reference to FIG. 4. The desired retarding torque 400 includes determining a first braking torque request 402 based on the operator input 404. In an embodiment, the operator input 404 includes the retarder lever that is actuated by the operator. A travel of the retarder lever is defined in terms of percentage with reference to a maximum travel that the retarder lever may allow. Percentage of the retarder lever travel and a total motor torque capability 406 of the machine 100, while limiting a grid fan noise, are communicated to a first multiplier 408 to determine the first braking torque request 402. The total motor torque capability 406 may be a maximum braking torque provided by the motors 210 at a given speed. The total motor torque capability 406 may be determined based on the given speed by using a map, a lookup table, a mathematical equation, and so on. In an embodiment, the total motor torque capability 406, as described with reference to FIG. 4, may be a theoretical value for purposes of determining the desired retarding torque 400, and not the real torque capability of the motors 210.

The drive-train ECM 310 may also determine a second braking torque request 410 based on a preset machine speed limit 412. The first braking torque request 402 and the second braking torque request 410 are communicated to a first comparator 414. The first comparator 414 compares the first braking torque request 402 and the second braking torque request 410, and outputs the desired retarding torque 400 to the brake ECM 312. The desired retarding torque 400 is a maximum of the first braking torque request 402 and the second braking torque request 410.

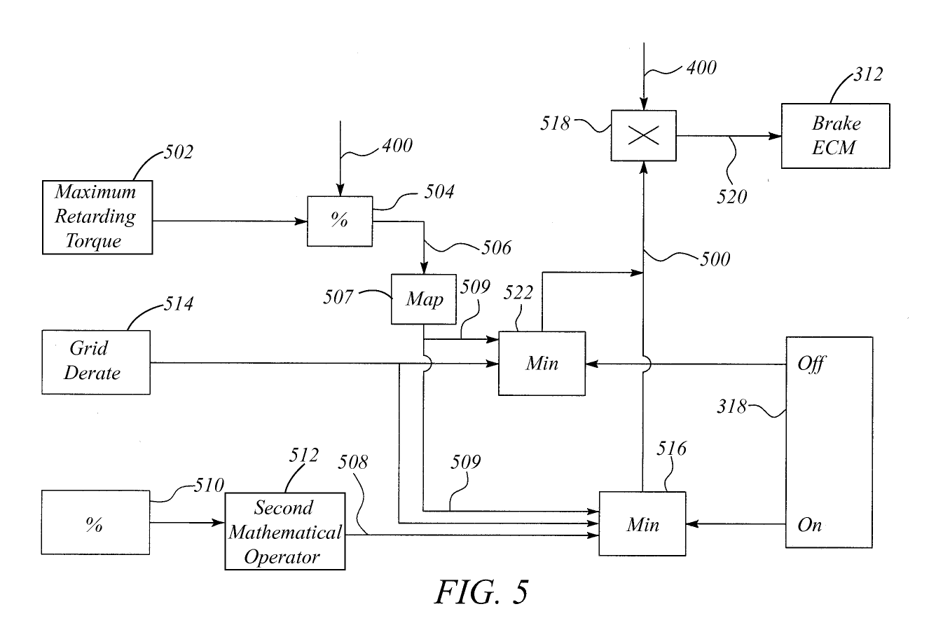

FIG. 5 shows a logical block diagram for determining a motor retarding torque ratio 500, according to an embodiment of the present disclosure. The drive-train ECM 310 may execute the steps described with reference to FIG. 5. The motor retarding torque ratio 500 includes determining a maximum retarding torque 502. The maximum retarding torque 502 of the electric retarding system 214 is based at least in part on a maximum grid fan speed. The maximum grid fan speed is predetermined according to a noise requirement of the machine 100. In an example, the maximum retarding torque 502 ranges from 40 to 60 percentage of the total motor torque capability 406 of the machine 100. The maximum retarding torque 502 is kept within the aforesaid range in order to keep a maximum speed of a resistor grid fan (not shown) below a predetermined threshold. Thus, the maximum retarding torque 502 may be lower than the total motor torque capability 406. In an example, the maximum speed of the resistor grid fan may be kept within a range of 800 to 1500 RPM. Limiting the maximum speed may reduce a noise generated by the resistor grid fan during electric retarding. The maximum retarding torque 502 and the desired retarding torque 400 are referred to a first mathematical operator 504. The first mathematical operator 504 is configured to determine a maximum retarding torque ratio 506 which is a ratio between the maximum retarding torque 502 and the desired retarding torque 400. The maximum retarding torque ratio 506 may be equal to, or less than, or greater then 1 depending on various situations. The maximum retarding torque ratio 506 may be provided to a map 507. The map 507 may provide an output 509 which is less than or equal to 1 based on the value of the maximum retarding torque ratio 506. For example, when the maximum retarding torque 506 is less than or equal to 1, the output 509 may be equal to the maximum retarding torque 506. However, when the maximum retarding torque 506 is greater than 1, the output 509 may be limited to 1.

The drive-train ECM 310 may also determine a complementary front braking ratio 508. The complementary front braking ratio 508 is based on a preset front braking ratio 510. The preset front braking ratio 510 is provided to a second mathematical operator 512. In an embodiment, the preset front braking ratio 510 may be 1/3. The preset front braking ratio 510 may be indicative of an optimum ratio of the desired retarding torque 400 that may be provided by the front brake module 304. The preset front braking ratio 510 may ensure a stable operation of the machine 100. The second mathematical operator 512 is configured to output the complementary front braking ratio 508 which may be a complement of the preset front braking ratio 510 (1—the preset front braking ratio 510). For example, if the preset front braking ratio 510 is 1/3, then the complementary front braking ratio 508 is 2/3.

The drive-train ECM 310 may also determine a grid derate 514. The grid derate 514 is defined with respect to a capacity of the resistor grid 216 to dissipate heat and an amount of cooling required for the resistor grid 216 for a given motor torque. A maximum value of the grid derate 514 may be less than 1 in order to account for reduction in the maximum grid fan speed. For example, the grid derate 514 may kept at a maximum of 2/3 of a resistor grid capacity. However, the grid derate 514 may be reduced based on the operating ambient condition of the machine 100. The ambient condition may include, but not limited to ambient air temperature, temperature of the resistor grid 216, and so on.

In an embodiment, the drive-train ECM 310 includes a second comparator 516. The second comparator 516 is active only when the front brake selector 318 in the user interface 314 is engaged. The output 509 of the map 507, the complementary front braking ratio 508 and the grid derate 514 are communicated to the second comparator 516. The second comparator 516 compares these inputs and outputs the motor retarding torque ratio 500. The motor retarding torque ratio 500 is minimum of the output 509, the complementary front braking ratio 508, and the grid derate 514. The motor retarding torque ratio 500 is referred to a second multiplier 518 that is also configured to receive the desired retarding torque 400. The second multiplier 518 is configured to provide an output torque 520. The output torque 520 is finally communicated to the brake ECM 312.

In another embodiment, the drive-train ECM 310 further includes a third comparator 522. The third comparator 522 is active only when the front brake selector 318 in the user interface 314 is disengaged. The output 509 of the map 507 and the grid derate 514 are communicated to the third comparator 522. The third comparator 522 compares these inputs and outputs the motor retarding torque ratio 500. The motor retarding torque ratio 500 is a minimum of the output 509 and the grid derate 514. Similar to the output of the second comparator 516, the motor retarding torque ratio 500 is referred to the second multiplier 518 that is also configured to receive the desired retarding torque 400. The second multiplier 518 is configured to give the output torque 520. The output torque 520 is finally communicated to the brake ECM 312. The output torque 520 may be indicative of a maximum value of braking torque that may be provided by the electric retarding system 214 based on various limitations of various components and/or requirements of the machine 100, such as the motors 210, the resistor grid 216, the grid fan, stability and noise requirements of the machine 100, and so on

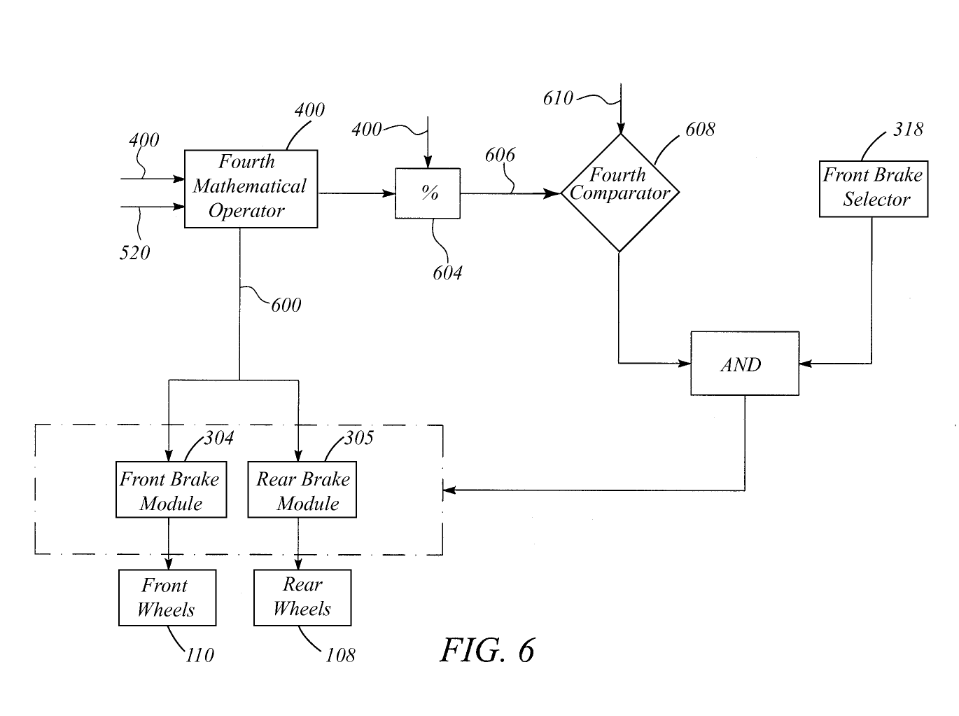

FIG. 6 shows a logical block diagram for determining a distribution of a friction braking torque 600, according to an embodiment of the present disclosure. The output torque 520 and the desired retarding torque 400 are communicated to the brake ECM 312. The brake ECM 312 includes a fourth mathematical operator 602 configured to derive a difference of the output torque 520 and the desired retarding torque 400. The difference between the output torque 520 and the desired retarding torque 400 have to be provided by the friction brake system 302 and is referred to as the friction braking torque 600. The friction braking torque 600 is referred to a fifth mathematical operator 604 and a ratio of the friction braking torque 600 and the desired retarding torque 400 is determined, hereinafter referred as ‘friction braking torque ratio 606’. The friction braking torque ratio 606 is communicated to a fourth comparator 608 that compares the friction braking torque ratio 606 with a predefined threshold ratio 610.

In an embodiment, the predefined threshold 610 may be a maximum ratio of the desired retarding torque 400 that may be applied on the front brake module 304 such that the machine 100 operates in a stable region. The predefined threshold 610 may be set to avoid a lock-up of the front set of wheels 110. In an example, the predefined threshold 610 may be a specific percentage of the desired retarding torque 400.

The fourth comparator 608 compares the friction braking torque ratio 606 with the predefined threshold 610, and sends a signal indicative of a true signal if the friction braking torque ratio 606 is less than the predefined threshold 610. The fourth comparator 608 sends a signal indicative of a false signal, if the friction braking torque ratio 606 is greater than or equal to the predefined threshold 610. Therefore, a true signal may indicate that the front brake module 304 may apply the friction braking torque 600 without losing stability. A false signal, on the other hand, may indicate that if the front brake module 304 applies the friction braking torque 600, the machine 100 may operate in an unstable region. The brake ECM 312 is configured to receive the signals from the fourth comparator 608 and a status of the front brake selector 318. The friction braking torque 600 may be selectively split between the front brake module 304 and the rear brake module 305 in various exemplary situations, as described below.

A first braking situation of the machine 100 includes the front brake selector 318 being engaged and the fourth comparator 608 outputting a true signal. In this situation, the brake ECM 312 outputs a true signal that is communicated with the friction brake system 302. The friction brake system 302 may then commands a front brake module 304 to apply the whole (100%) of the friction braking torque 600. Further, the oil cooling system 306 may be controlled to provide sufficient cooling to the front brake module 304.

A second braking situation of the machine 100 includes the front brake selector 318 being disengaged and the fourth comparator 608 outputting a true signal. In this situation, the brake ECM 312 outputs a false signal that is communicated to the friction brake system 302. The friction braking torque 600 is then split between the front brake module 304 and the rear brake module 305 in a predetermined ratio. For example, the friction brake system 302 may command the front brake module 304 to apply 40% of the friction braking torque 600 and command the rear brake module 305 to apply 60% of the friction braking torque 600. Further, the oil cooling system 306 may be controlled to provide sufficient cooling to the front and rear brake modules 304, 305. For example, the oil cooling system 306 may provide separate flows of a brake cooling fluid to the front and rear brake modules 304, 305 for necessary cooling.

A third braking situation of the machine 100 includes the front brake selector 318 is engaged and the fourth comparator 608 output a false signal. In this situation, the brake ECM 312 output a false signal that is communicated to the friction brake system 302. The friction braking torque 600 is then split between the front brake module 304 and the rear brake module 305 in a predetermined ratio. Further, the oil cooling system 306 may be controlled to provide sufficient cooling to the front and rear brake modules 304, 305.

A fourth braking situation of the machine 100 includes the front brake selector 318 is disengaged and the fourth comparator 608 output a false signal. In this situation, the brake ECM 312 output a false signal that is communicated with the friction brake system 302. The friction braking torque 600 is then split between the front brake module 304 and the rear brake module 305 in a predetermined ratio. Thus, the brake ECM 312 may actuate the front brake module 304, based on operating conditions, even if the front brake selector 318 is disengaged. Further, the oil cooling system 306 may be controlled to provide sufficient cooling to the front and rear brake modules 304, 305.

### INDUSTRIAL APPLICABILITY

The braking system may utilize motors of the electric drive system to provide the retarding power to the machine. The retarding power may be dissipated in the form of heat through the resistor grid, in which the heat dissipation may be enhanced by providing one or more fans. However, the fans tend to generate noise at high speeds. The braking system may also include the friction brake system that may supplement the electric retarding system. However, in certain situation, the machine may experience instability during electric retarding and/or friction braking.

The present disclosure is related to the braking system 300 for the machine 100. The braking system 300 includes the electric retarding system 214 and the friction brake system 302. Based on various situations, the braking system 300 may selectively distribute a desired retarding torque 400 between the electric retarding system 214 and the friction brake system 302. Further, the braking system 300 may selectively split a friction braking torque 600 between the front brake module 304 and the rear brake module 305.

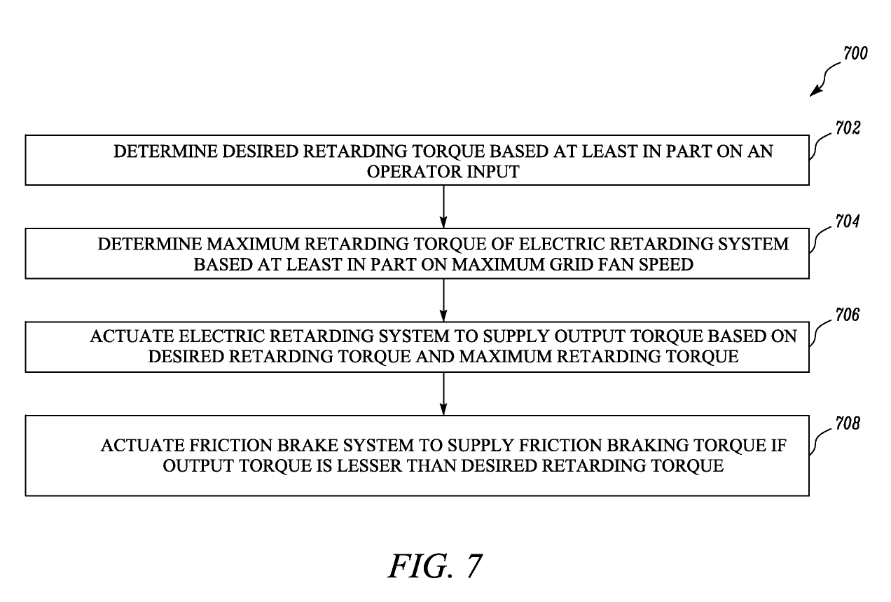

The present disclosure is also related to a method 700 for braking the machine 100. FIG. 7 illustrates the method 700 for braking the machine 100, according to an embodiment of the present disclosure. The method 700 includes determining the desired retarding torque 400 based at least in part on an operator input 404. At step 702, the method 700 includes determining the first braking torque request 402 based on the operator input 404. The operator input 404 is received from the retarder lever of the user interface 314. The operator operates the retarder lever for a desired speed of the machine 100. The first braking torque request 402 is determined based on the total motor torque capability 406 of the machine 100. The desired retarding torque 400 further includes determining the second braking torque request 410 based on the preset machine speed limit 412. The first braking torque request 402 and the second braking torque request 410 are communicated to the drive-train ECM 310. The first comparator 414 of the drive-train ECM 310 selects maximum of the first braking torque request 402 and the second braking torque request 410 as the desired retarding torque 400.

The method 700 further includes determining the maximum retarding torque 502 of the electric retarding system 214 based at least in part on a maximum grid fan speed, at step 704. The maximum retarding torque 502 and the desired retarding torque 400 may be communicated to the first mathematical operator 504 of the drive-train ECM 310 to determine the maximum retarding torque ratio 506. The maximum retarding torque ratio 506 may be a ratio between the maximum retarding torque 502 and the desired retarding torque 400. The maximum retarding torque ratio 506 is selectively used to determine the motor retarding torque ratio 500. The drive-train ECM 310 may also determine a complementary front braking ratio 508. The second mathematical operator 512 is configured to output the complementary front braking ratio 508 which may be a complement of the preset front braking ratio 510 (1—the preset front braking ratio 510). The drive-train ECM 310 may also determine the grid derate 514. The grid derate 514 may be defined with respect to a capacity of the resistor grid 216 to dissipate heat.

At step 706, the method 700 further includes actuating the electric retarding system 214 to supply the output torque 520. In an embodiment, the drive-train ECM 310 includes the second comparator 516 that is active only when the front brake selector 318 is engaged. The output 509, the complementary front braking ratio 508 and the grid derate 514 are communicated to the second comparator 516, which compares these inputs and outputs the motor retarding torque ratio 500. The motor retarding torque ratio 500 is referred to the second multiplier 518, which is also configured to receive the desired retarding torque 400 to provide the output torque 520.

In another embodiment, the drive-train ECM 310 includes a third comparator 522. The third comparator 522 is active only when the front brake selector 318 in the user interface 314 is disengaged. The output 509 and the grid derate 514 are communicated to the third comparator 522, which compares these inputs and outputs the motor retarding torque ratio 500. Similar to the output of the second comparator 516, the motor retarding torque ratio 500 is referred to the second multiplier 518, which is also configured to receive the desired retarding torque 400, to give the output torque 520. The output torque 520 may be the maximum braking torque that may be provided by the electric retarding system 214. The electric retarding system 214 may be actuated accordingly to apply the output torque 520.

At step 708, the method 700 further includes actuating the friction brake system 302 to supply the friction braking torque 600. The drive-train ECM 310 includes the output torque 520 and the desired retarding torque 400, which are communicated to the brake ECM 312. The brake ECM 312 includes the fourth mathematical operator 602 configured to derive a difference of the output torque 520 and the desired retarding torque 400 to output the friction braking torque 600. The friction braking torque 600 is referred to the fifth mathematical operator 604 and the friction braking torque ratio 606 is determined based on the friction braking torque 600 and the desired retarding torque 400. The friction braking torque ratio 606 is communicated to the fourth comparator 608 that compares the friction braking torque ratio 606 with a predefined threshold 610.

The friction braking torque ratio 606 is communicated to the fourth comparator 608 that compares the friction braking torque ratio 606 with the predefined threshold 610, and sends a signal indicative of a true signal if the friction braking torque ratio 606 is less than the predefined threshold 610 and sends a signal indicative of a false signal, if the friction braking torque ratio 606 is greater than or equal to the predefined threshold 610.

In case, the brake ECM 312 outputs a false signal, the friction braking torque 600 is split between the front brake module 304 and the rear brake module 305 based on the predetermined ratio irrespective of the position of the front brake selector 318. Further, if the brake ECM 312 outputs a true signal and the front brake selector 318 is engaged, the friction braking torque 600 may be wholly applied by the front brake module 304.

The braking system 300 of the present disclosure includes the maximum retarding torque 502 as one of the limiting factors for the braking capability of the motors 210, and not the total motor torque capability 406. As explained before, the maximum retarding torque 502 may be lower than the total motor torque capability 406 in order to reduce a heat dissipation requirement of the resistor grid 216. Hence, the maximum grid fan speed may be lowered to a predetermined value. Thus, noise generated by the grid fan may be reduced. Additionally, the grid derate 514 may also be reduced in order to account for the reduction in the maximum grid fan speed. Thus, the output torque 520 that may be provided by the electric retarding system 214 may be reduced

However, the braking system 300 may provide the desired retarding torque 400 despite a reduction in the output torque 520. The braking system 300 may dynamically distribute the friction braking torque 600 between the front brake module 304 and the rear brake module 305 in order to provide the whole of the desired retarding torque 400, while ensuring a stable operation of the machine 100. Hence, any lock-up of the front and/or rear set of wheels 110, 108 may be prevented.

Further, the oil cooling system 306 may also be regulated to provide sufficient cooling to the front and rear brake modules 304, 305 based on various braking situations. For example, when only the front brake module 304 is actuated, the oil cooling system 306 may provide an amount of the brake cooling fluid to the front brake module 304 for necessary cooling. When both the front and rear brake modules 304, 305 are actuated, the oil cooling system 306 may provide separate flows of the brake cooling fluid to the front and rear brake modules 304, 305 for necessary cooling.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

1. A method of braking a machine having an electric retarding system and a friction brake system, the method comprising:
determining a desired retarding torque based at least in part on an operator input;
determining a maximum retarding torque of the electric retarding system based at least in part on a maximum grid fan speed, wherein the maximum grid fan speed is predetermined according to a noise requirement of the machine;
selecting a minimum value of a ratio between the maximum retarding torque and the desired retarding torque and a resistor grid derate;
determining an output torque of the electrical retarding system by multiplying the desired retarding torque with the minimum value;
actuating the electric retarding system to supply the output torque; and
actuating the friction brake system to supply a friction braking torque if the output torque is lesser than the desired retarding torque.

2. The method of claim 1, wherein determining the desired retarding torque comprises:
determining a first braking torque request based on the operator input;
determining a second braking torque request based on a preset machine speed limit; and
selecting a maximum of the first braking torque request and the second braking torque request as the desired retarding torque.

3. (canceled)

4. The method of claim 1 further comprises:
determining if a front brake selector is engaged; and
selecting a minimum of the ratio between the maximum retarding torque and the desired retarding torque, the resistor grid derate, and a preset braking ratio.

5. The method of claim 1 further comprises:
determining if a ratio between the friction braking torque and the desired retarding torque is lesser than a predetermined threshold;
determining if the front brake selector is engaged; and
actuating a front brake module associated with a front set of wheels to apply the friction braking torque.

6. The method of claim 5 further comprises:
determining if a ratio between the friction braking torque and the desired retarding torque is greater than or equal to the predetermined threshold; and
splitting the friction braking torque between the front brake module and a rear brake module associated with a rear set of wheels in a predetermined ratio.

7. The method of claim 5 further comprises:
determining if the front brake selector is disengaged; and
splitting the friction braking torque between the front brake module and the rear brake module associated with the rear set of wheels in a predetermined ratio.

8. A method of braking a machine having an electric retarding system and a friction brake system, the method comprising:
determining a desired retarding torque based at least in part on an operator input;
determining a maximum retarding torque of the electric retarding system based on at least a maximum grid fan speed, wherein the maximum grid fan speed is predetermined according to a noise requirement of the machine;
selecting a minimum value of a ratio between the maximum retarding torque and the desired retarding torque and a resistor grid derate;
determining an output torque of the electrical retarding system by multiplying the desired retarding torque with the minimum value;
actuating the electric retarding system to supply the output torque; and
actuating the friction brake system to supply a friction braking torque if the output torque is lesser than the desired retarding torque, wherein the friction braking torque is selectively split between a front brake module associated with a front set of wheels and a rear brake module associated with a rear set of wheels based at least in part on a ratio between the friction braking torque and the desired retarding torque.

9. The method of claim 8, wherein determining the desired retarding torque comprises:
determining a first braking torque request based on the operator input;
determining a second braking torque request based on a preset machine speed limit; and
selecting a maximum of the first braking torque request and the second braking torque request as the desired retarding torque.

10. (canceled)

11. The method of claim 8 further comprises:
determining if a front brake selector is engaged; and
selecting a minimum of the ratio between the maximum retarding torque and the desired retarding torque, the resistor grid derate, and a preset front braking ratio.

12. The method of claim 8 further comprises:
determining if a ratio between the friction braking torque and the desired retarding torque is lesser than a predetermined threshold;
determining if the front brake selector is engaged; and
actuating the front brake module to apply the friction braking torque.

13. The method of claim 12 further comprises:
determining if a ratio between the friction braking torque and the desired retarding torque is greater than or equal to the predetermined threshold; and
splitting the friction braking torque between the front brake module and the rear brake module in a predetermined ratio.

14. The method of claim 12 further comprises:
determining if the front brake selector is disengaged; and
splitting the friction braking torque between the front brake module and the rear brake module in a predetermined ratio.

15. A machine comprising:
a front set of wheels and a rear set of wheels;
an electric retarding system associated with the rear set of wheels;
a friction brake system comprising:
a front brake module associated with the front set of wheels; and
a rear brake module associated with the rear set of wheels;
a control module communicably coupled to the electric retarding system and the friction brake system, the control module configured to:
determine a desired retarding torque based at least in part on an operator input;
determine a maximum retarding torque of the electric retarding system based on at least a maximum grid fan speed, wherein the maximum grid fan speed is predetermined according to a noise requirement of the machine;
select a minimum value of a ratio between the maximum retarding torque and the desired retarding torque and a resistor grid derate;
determine an output torque of the electrical retarding system by multiplying the desired retarding torque with the minimum value;
actuate the electric retarding system to supply the output torque; and
actuate the friction brake system to supply a friction braking torque if the output torque is lesser than the desired retarding torque, wherein the friction braking torque is selectively split between the front brake module and the rear brake module based on a ratio between the friction braking torque and the desired retarding torque.

16. (canceled)

17. The machine of claim 15, wherein the control module is further configured to:
determine if a front brake selector is engaged; and
select a minimum of the ratio between the maximum retarding torque and the desired retarding torque, the resistor grid derate, and a preset front braking ratio.

18. The machine of claim 15, wherein the control module is further configured to:
determine if a ratio between the friction braking torque and the desired retarding torque is lesser than a predetermined threshold;
determine if a front brake selector is engaged; and
actuate the front brake module to apply the friction braking torque.

19. The machine of claim 18, wherein the control module is further configured to:
determine if a ratio between the friction braking torque and the desired retarding torque is greater than or equal to the predetermined threshold; and
split the friction braking torque between the front brake module and the rear brake module in a predetermined ratio.

20. The machine of claim 18, wherein the control module is further configured to:
determine if a front brake selector is disengaged; and
splitting the friction braking torque between the front brake module and a rear brake module associated with a rear set of wheels in a predetermined ratio.
